(19) United States
(12) Patent Application Publication
(10) Pub. No.: US 2012/0047582 A1
(43) Pub. Date: Feb. 23, 2012

(54) DATA DELETING METHOD FOR COMPUTER STORAGE DEVICE

(75) Inventor: Yi-Hsin CHAN, Chung-Ho City (TW)

(73) Assignee: NEXCOM International Co., Ltd.

(21) Appl. No.: 12/860,121

(22) Filed: Aug. 20, 2010

(51) Int. Cl. G06F 12/14; G06F 21/24

(52) U.S. Cl. 726/26

(57) ABSTRACT

A data deleting method for a computer storage device is implemented by first setting a default status of a delete-able status for a deletion record file in the storage device when the storage device is powered on, where the default status can be enable or disable. If the delete-able status of the deletion record file is kept in an enable state before the storage device is powered off, the whole data stored in the storage device is deleted automatically when the storage device is powered on next time. This is because the enable state of the delete-able status of the deletion record file is detected by a control unit of the storage device. Therefore, the method can prevent the data in the storage device from any theft or unauthorized usage.

### BACKGROUND OF THE INVENTION

1. Field of the Invention

The present invention is related to a computer storage device, and in particular to a data deleting method for a computer storage device.

2. Description of Prior Art

No doubt, the computer is one of the greatest inventions in the 20^{th} century. With its convenience, the computer is now widely used for everything and everywhere.

The most advantageous feature of the computer lies in that it is equipped with a storage device such as a hard disk driver, an optical disk driver and a memory disk to permanently store a user's data including documents, letters, photos, movies and audio files. With the advancement of the semiconductor industry, the capacity of the storage device is increased immensely. As a result, the user can store all the required data and files on a large scale in the storage device no matter what they are (whether the data and files are important or not).

Since the user desires to have a portable computer, more and more notebook computers are recently produced. Furthermore, various portable storage devices such as a USB flash drive (UFD), a memory card or an external hard disk are developed and become the most popular peripheral devices of the computer. However, since these portable storage devices can be freely and incautiously taken away by the user to the outdoors, the data security issue of them thereof must be taken into a serious consideration. For example, when the user uses his notebook computer or USB flash drive in an outdoor café, the notebook computer may be robbed or stolen, and the USB flash drive may be pulled out of the computer by other people. As a result, the data stored in the notebook computer or the USB flash drive may be exposed by someone with bad will. Therefore, in view of the above, it is an important issue for those skilled in this art to develop a storage device considering convenience, portability and security at the same time.

The current portable storage device for the computer usage such as a USB flash drive or memory card each has a function of setting a security lock, whereby the user has to input the correct key password to access the data stored therein to thereby protect the data. However, with the advancement of information technology, various programs for decrypting password are already developed and widely spread in the Internet. Further, many technically sophisticated hackers try to steal or browse other people's data stored in the computer via the Internet, the traditional way of protecting data only by a key password has become insufficient in terms of security.

According to the above, considering the convenience, even confidential or secret data may be inevitably stored in a notebook or other portable storage device for any purpose. Therefore, how to protect such confidential or secret data in any kind of storage device has become a general issue for computer professionals including the staff responsible for national security.

### SUMMARY OF THE INVENTION

The present invention is to provide a data deleting method for a computer storage device, whereby the data stored therein can be automatically deleted when the storage device is powered on to thereby prevent the data from any thief or unauthorized usage.

According to the present invention, a default status is first set for a deletion record file in a storage device when the storage device is powered on, wherein the default status can be enable or disable. If the deletion record file is kept in the enable status before the storage device is powered off, the whole data stored in the storage device is automatically deleted when the storage device is powered on next time. This is because the enable status of the deletion record file is detected by a control unit within the storage device.

In comparison with the prior art, the present invention has advantageous features as follows. When the user is using a notebook computer or a portable storage device, the deletion record file of the storage device can be kept in the enable status by a control software. In this way, if the computer or the storage device is robbed or stolen so someone with a bad will have a chance to turn off the computer or remove the storage device from the computer, however, with the deletion record file kept in the enable status, any embedded storage device within the computer or the standalone storage device itself will automatically delete the data stored therein when the computer or the storage device is powered on next time. Thus, it is unnecessary for the user to delete the data stored in his computer or storage device regularly and his personal secrets or confidential data can be protected more firmly and easily.

### BRIEF DESCRIPTION OF THE DRAWINGS

FIG. 1 is a concept diagram depicting a preferred embodiment of the present invention;

FIG. 2 is a block diagram depicting a preferred embodiment of the present invention;

FIG. 3A is a concept diagram depicting the working memory of a preferred embodiment of the present invention;

FIG. 3B is a concept diagram depicting the data memory of a preferred embodiment of the present invention;

FIG. 4 is a flow chart depicting a preferred embodiment of the present invention;

FIG. 5 is a block diagram depicting another preferred embodiment of the present invention; and

FIG. 6 is a flow chart depicting another preferred embodiment of the present invention.

### DETAILED DESCRIPTION OF THE INVENTION

The preferred embodiments of the present invention will be described in more detail with reference to the accompanying figures.

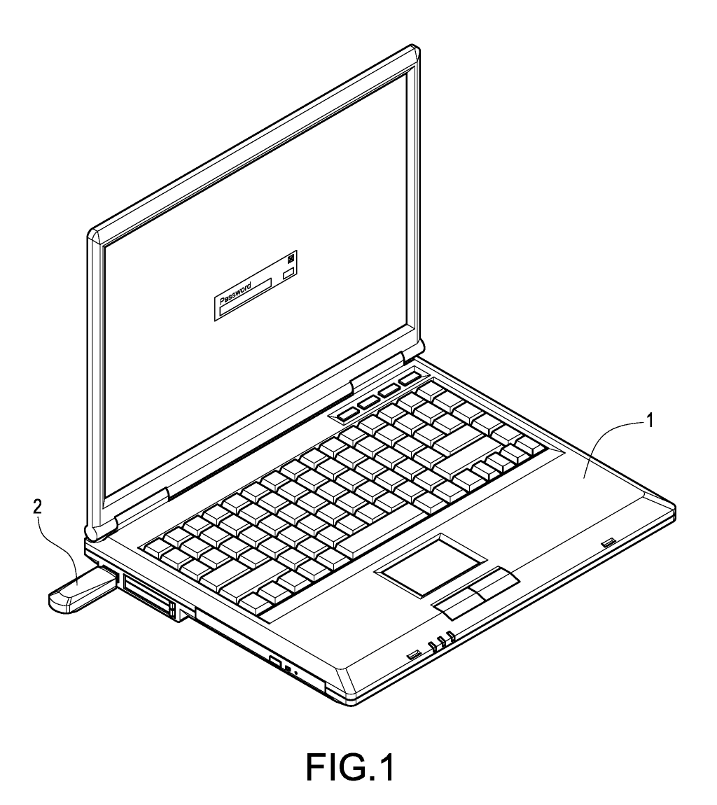

Please refer to FIG. 1, which is a concept diagram depicting a preferred embodiment of the present invention. As shown in this figure, the present inventive method is applied between a computer 1 and a portable storage device 2 (referred as “storage device 2” hereinafter). The computer 1 shown in FIG. 1 is a laptop computer, and the storage device 2 is a USB flash drive as an example. However, the computer 1 may be a desktop computer or any computer system, and the storage device 2 may be a memory card, a built-in hard disk drive or an external hard disk drive. Anyway, the computer 1 and the storage device 2 are not limited to the above.

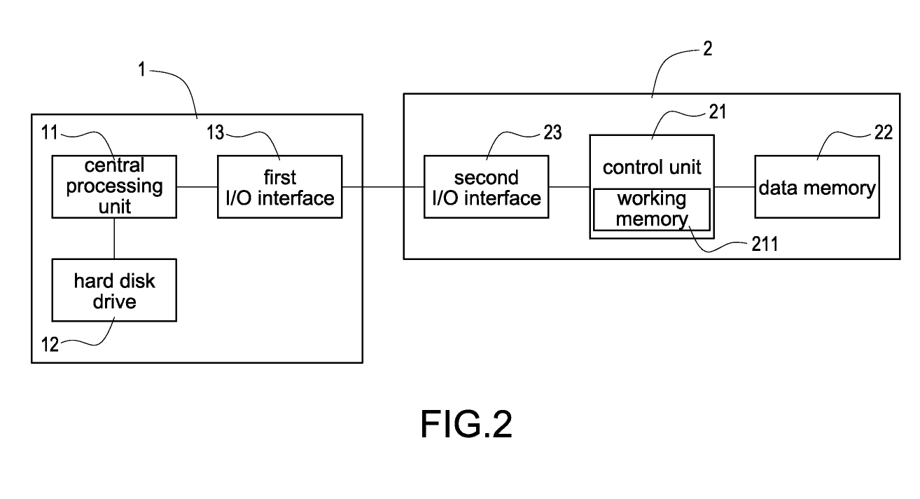

Please refer to FIG. 2, which is a block diagram depicting a preferred embodiment of the present invention. The computer 1 includes a central processing unit 11, a hard disk drive 12, and a first I/O interface 13. The storage device 2 includes a control unit 21, a data memory 22, and a second I/O interface 23. The control unit 21 further includes a working memory 211. The working memory 211 is a storage element of small capacity in the control unit 21 for storing program code and data necessary for the operation of the control unit 21. The data memory 22 is another storage element of large capacity for storing the user's data. The computer 1 and the storage device 2 are electrically connected to each other via the first I/O interface 13 and the second I/O interface 23. When the computer 1 is turned on, the first I/O interface 13 provides electricity to the storage device 2, so that the storage device 2 can be powered on. The first I/O interface 13 and the second I/O interface 23 are configured as the transmission interface between the computer 1 and the storage device 2. The standard of Universal Serial Bus (USB) or External Serial Advanced Technology Attachment (eSATA) may be as an interface example for the first I/O interface 13 and the second I/O interface 23.

The control unit 21 is electrically connected to the data memory 22 and the second I/O interface 23. The second I/O interface 23 received commands sent by the computer 1 and base on those commands to operate on the data memory 22.

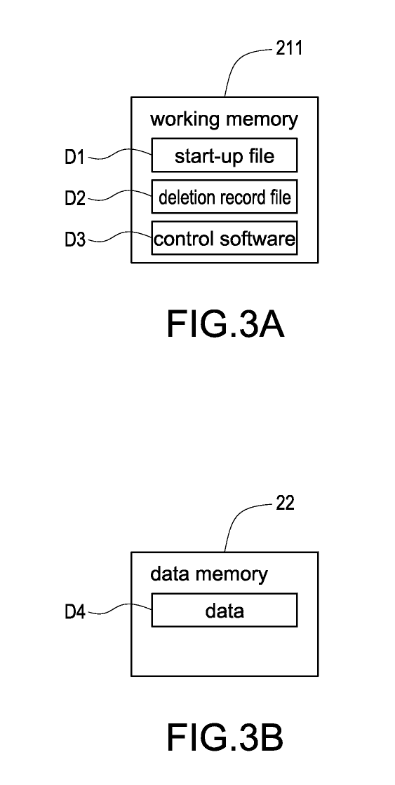

FIG. 3A is a concept diagram depicting the working memory of a preferred embodiment of the present invention. The working memory 211 is stored therein with a start-up file D1, a deletion record file D2, and control software D3. FIG. 3B is a concept diagram depicting the data memory of a preferred embodiment of the present invention. The data memory 22 is configured to store the data D4 of a user. Each time the storage device 2 is powered on again, the control unit 22 automatically executes the start-up file D1 in the working memory 211. The deletion record file D2 will be read during the start-up file D1 is executed. The deletion record file D2 represents a delete-able status to indicate whether the data D4 in the data memory 22 is allowed to be deleted or not.

It should be noted that, in addition to a file, the deletion record file D2 may be a bit flag only within the working memory 211 as long as it can be used to record whether the data D4 is allowed to be deleted or not. Thus, any other recording type for the deletion record file D2 is possible for the present invention.

The control software D3 is executed in the computer 1. The central processing unit 11 sends a control command based on the control software D3 to set the delete-able status of the deletion record file D2 to become enable or disable. The control software D3 can be stored in the working memory 211 and automatically loaded in the computer 1 for execution when the storage device 1 is connected to the computer 1. Furthermore, the control software D3 can be also stored in the hard disk drive 12 of the computer 1 and executed directly in the computer 1. However, the storage place for the control software D3 is not limited thereto.

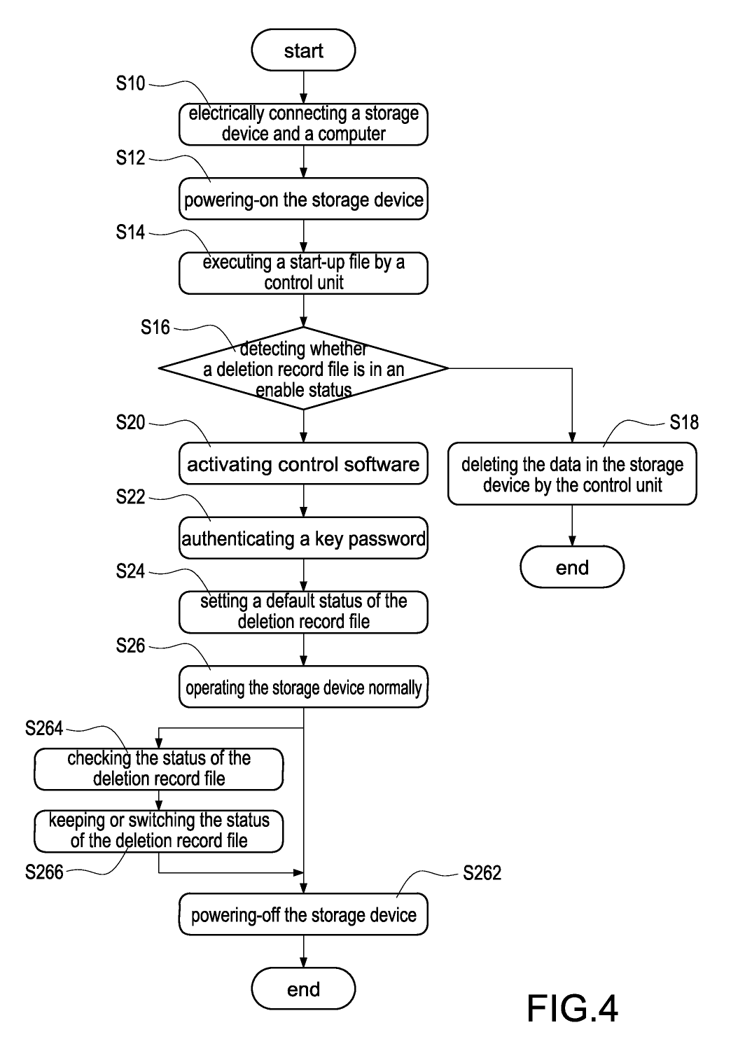

FIG. 4 is a flow chart depicting a preferred embodiment of the present invention. First, the storage device 2 is connected to the computer 1 (step S10). For example, a USB flash drive is inserted into a socket of a notebook computer. Then, with the computer 1 being turned on, the storage device 2 is powered on (step S12). Further, the control unit 21 executes the start-up file D1 within the working memory 211 (step S14). In this way, the start-up file D1 reads the deletion record file D2. Finally, the control unit 21 reads the delete-able status of the deletion record file D2 to detect whether the deletion record file D2 is in the enable state or not (step S16).

After the step S16, if the control unit 21 detects that the delete-able status of the deletion record file D2 is in the enable state, it means that the central processing unit 11 does not send the control command based on the control software D3 to disable the delete-able status of the deletion record file D2 normally before the storage device 2 is powered off (e.g. the USB flash drive is removed from the computer 1). As a result, the data stored in the storage device 2 is deleted (step S18). More specifically, in the step S18, the whole data D4 stored in the data memory 22 of the storage device 2 is deleted while the files of the working memory 211 are maintained. In this way, after the step S18, the storage device 2 after the data memory 22 being reformatted can still execute the data deleting method of the present invention by means of the star-up file D1, the deletion record file D2, and the control software D3. However, it should be noted that, after the whole data D4 in the data memory 22 is deleted, if the data memory 22 is used to store data again, the user has to format the data memory 22 first. Since the files in the working memory 211 are not deleted by the method of the present invention, it is unnecessary to format the working memory 211 and the working memory 211 is ready for use.

After the step S16, if the control unit 21 detects that the delete-able status of the deletion record file D2 is in the disable state, it means the central processing unit 11 disables the delete-able status of the deletion record file D2 via the control software D3 before the storage device 2 is powered off. Therefore, the data D4 in the data memory 22 will not be deleted when the storage device 2 is powered on again.

For a normal operation, if the data deleting method of the present invention is to be used, the control software D3 will be opened and executed by the computer 1 (step S20) after the storage device 2 is powered on and the data D4 without being deleted. Before the data memory 22 can be accessed, a key password by the user of the computer 1 must be authenticated by the control software D3 (step S22). After the key password is authenticated as a correct password, the central proceeding unit 11 sends the control command to the control unit 21 via the control software D3 too, so that the control unit 21 will allow the legal usage of the data memory 22 and set (sets) a default status of the deletion record file D2 based on the control command (step S24). As a result, the storage device 2 can be normally operated by the user (step S26).

As mentioned in the above, the default status of the deletion record file D2 may be set as an enable or a disable state based on the user's need. For example, the user can select to disable the delete-able status of the deletion record file D2 last time even with the default status being enable before the storage device 2 is powered off, as such, the delete-able status of the deletion record file D2 will be determined as at a disable state in the step S16 when the storage device 2 is powered on next time, so that the step S18 will not be executed. However, after the steps S20 and S22 are executed completely, the delete-able status of the deletion record file D2 will be set as the default status again which might be enable or disable. Finally, at the end of use, the storage device 2 is powered off (step S262).

It should be noted that, after the steps S26 and before the step S262, the user of the computer 1 can execute via the control software D3 repeatedly to check the status of the delete-able status of the deletion record file D2 after the key password is authenticated (step S264). Furthermore, following Step 264, the user can select to keep or switch the delete-able status of the deletion record file D2 based on his need (Step S266). More specifically, the user checks the current delete-able status of the deletion record file D2 and decides whether the current status should be kept or switched based on the result of check. In this way, before the step S262, the user can set the delete-able status of the deletion record file D2 as desired regardless of the default status set at the step S24 via the control software D3.

For example, if the default state for the delete-able status of the deletion record file D2 is selected as enable after the step S24, the user can check the deletion record file D2 in the step S264 and switch the delete-able status of the deletion record file D2 to a disable state in the step S266. As a result, when the storage device 2 is powered on next time, the data D4 in the data memory 22 will not be deleted. On the other end, if the default state for the delete-able status of the deletion record file D2 is selected as enable after the step S24, the user can check the deletion record file D2 in the step S264 and keep the delete-able status of the deletion record file D2 as enable in the step S266. As a result, when the storage device 2 is powered on next time, the whole data D4 will be deleted in the step S18.

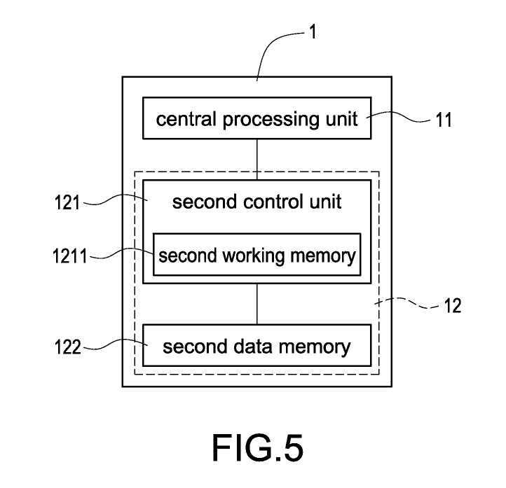

In addition to being applied to the storage device 2, the data deleting method of the present invention can be directly applied to a hard disk drive 12 within the computer 1. The hard disk drive 12 may be a traditional mechanical hard disk drive or a Solid State Disk (SSD), which will be described later. FIG. 5 is a block diagram depicting another preferred embodiment of the present invention. The storage device 2 used in the previous embodiment is replaced by the hard disk drive 12. The hard disk drive 12 is electrically connected to the central processing unit 11 and has a second control unit 121 and a second data memory 122. The second control unit 121 further includes a second working memory 1211. The second working memory 1211 has the same arrangement as that of the working memory 211 shown in FIG. 3A. The second data memory 122 has the same arrangement as that of the data memory 22 shown in FIG. 3B. If the hard disk drive 12 is a traditional mechanical hard disk drive, the second data memory 122 is embodied as a magnetic disk region (not shown).

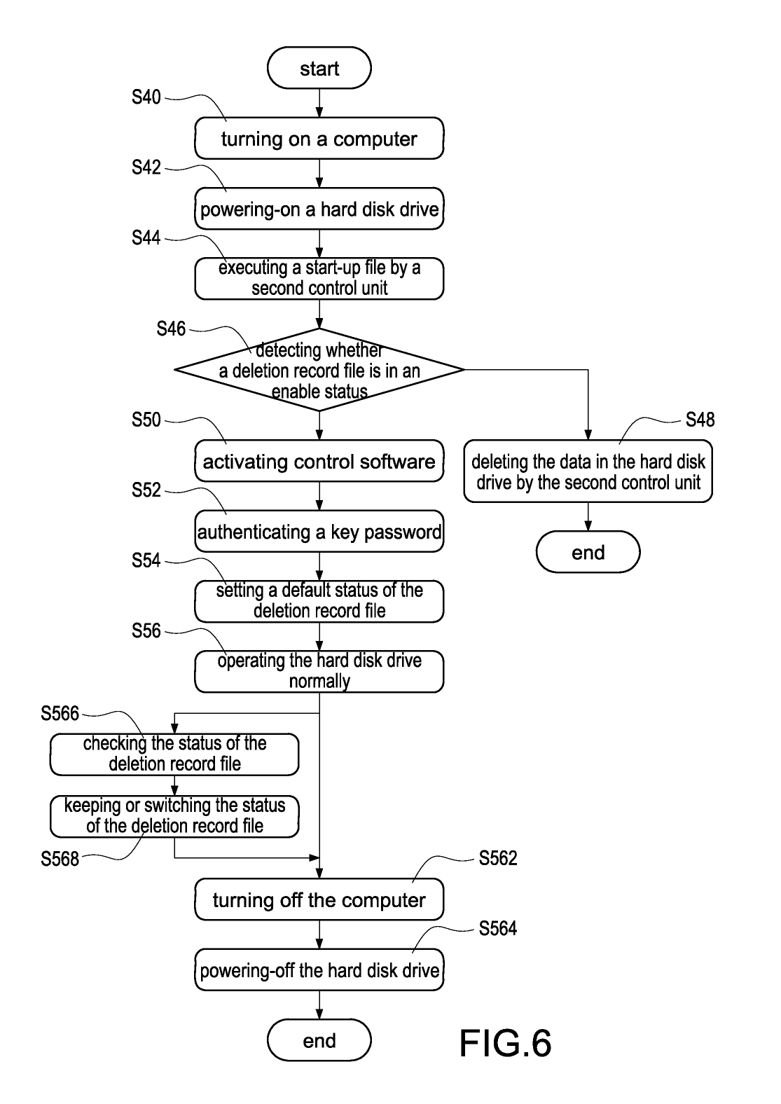

Please refer to FIG. 6, which is a flow chart depicting another preferred embodiment of the present invention. If the method of the present invention is used within the computer 1, the computer 1 has to be turned on first (step S40), so that the hard disk drive 12 can be powered and activated by the computer 1 (step S42). After the hard disk drive 12 is activated, the second control unit 121 executes the star-up file D1 in the second working memory 1211 (step S44). The start-up file D1 reads the deletion record file D2, whereby the second control unit 121 can detect whether the delete-able status of the deletion record file D2 is in the enable state or not (step S46).

After the step S46, if the second control unit 121 detects that the delete-able status of the deletion record file D2 is in the enable state, the second control unit 121 immediately deletes the data storage in the hard disk drive 12 (step S48). More specifically, the second control unit 121 deletes the whole data D4 in the second data memory 122.

After the step S46, if the second control unit 21 detects that the delete-able status of the deletion record file D2 is in the disable state, the data D4 stored in the second data memory 122 will not be deleted this time after the hard disk drive 12 is powered on.

Next, if the data deleting method of the present invention is to be used in the normal operation of the hard disk drive 12, the hard disk drive 12 opens the control software D3 after it is powered on (step S50) and authenticates the key password (step S52). In the present embodiment, the control software D3 is stored in the second working memory 1211 and executed in the computer 1. After the key password is authenticated as a correct password, the central processing unit 11 sends a control command to the second control unit 121 via the control software D3. The second control unit 121 sets the default status of the deletion record file D2 based on the control command (step S54). Finally, the user can operate the hard disk driver 12 normally (step S56) and turn off the computer 1 at the end of use (step S562), so that the hard disk drive 12 can be powered off (step S564).

After the step S56 and before the step S562, the user can check the delete-able status of the deletion record file D2 repeatedly (step S566), and decides to keep or switch the delete-able status of the deletion record file D2 based on the result of check (step S568). Before the step S562, the user checks whether the delete-able status of the deletion record file D2 is in the enable or the disable state, and sets the delete-able status of the deletion record file D2 as a desired state, thereby deciding whether the data D4 in the second data memory 122 is deleted or not when the hard disk driver 12 is powered on next time.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A data deleting method for a computer storage device, applied between a computer and a storage device, the storage device having a control unit and a data memory, the control unit further comprising a working memory, the method including steps of:
a) powering-on the storage device;
b) detecting whether a delete-able status of a deletion record file in the working memory is in an enable state or not by the control unit; and
c) if the delete-able status of the deletion record file in the working memory is in an enable state in the step b), deleting data in the storage device by the control unit.

2. The data deleting method for a computer storage device according to claim 1, wherein the working memory further includes a start-up file, and the method further includes, prior to the step b), steps of:
b01) executing the start-up file by the control unit; and
b02) reading the deletion record file by the start-up file.

3. The data deleting method for a computer storage device according to claim 1, wherein the whole data in the data memory is deleted in the step c).

4. The data deleting method for a computer storage device according to claim 1, wherein the storage device is a USB flash drive, a memory card or an external hard disk drive, the storage device is powered on in the step a) when being electrically connected to the computer.

5. The data deleting method for a computer storage device according to claim 1, prior to the step a), further including steps of:
a01) powering-on the storage device;
a02) sending a control command to the storage device by a central processing unit of the computer;
a03) setting a default status of the deletion record file by the control unit based on the control command;
a04) after the step a03), checking the status of the deletion record file;
a05) switching the state of the delete-able status of the deletion record file by the control unit based on the control command; and
a06) powering-off the storage device.

6. The data deleting method for a computer storage device according to claim 5, wherein the central processing unit sends the control command via control software stored in a hard disk drive of the computer.

7. The data deleting method for a computer storage device according to claim 5, wherein the central processing unit sends the control command via control software stored in the working memory.

8. The data deleting method for a computer storage device according to claim 5, prior to the step a02), further including a step a021) of authenticating a key password.

9. The data deleting method for a computer storage device according to claim 1, wherein the deletion record file is a flag in the working memory.

10. A data deleting method for a computer storage device, applied between a computer and a hard disk drive, the hard disk drive being provided within the computer and having a second control unit and a second data memory, the second control unit further comprising a working memory, the method including steps of:
a) turning on the computer to power-on the hard disk drive;
b) detecting whether the delete-able status of a deletion record file in the working memory is in an enable state or not by the second control unit;
c) if the delete-able status of the deletion record file in the working memory is in an enable state in the step b), deleting data in the hard disk drive by the second control unit.

11. The data deleting method for a computer storage device according to claim 10, wherein the hard disk drive is a traditional mechanical hard disk drive or a Solid State Disk (SSD).

12. The data deleting method for a computer storage device according to claim 10, wherein the computer is a notebook computer.

13. The data deleting method for a computer storage device according to claim 10, wherein the working memory further includes a start-up file, and the method further includes, prior to the step b), steps of:
b01) executing the start-up file by the second control unit; and
b02) reading the deletion record file by the start-up file.

14. The data deleting method for a computer storage device according to claim 10, wherein the whole data in the second data memory is deleted in the step c).

15. The data deleting method for a computer storage device according to claim 10, prior to the step a), further including steps of:
a01) turning on the computer to power-on the hard disk drive;
a02) sending a control command to the hard disk drive by a central processing unit of the computer;
a03) setting a default status of the deletion record file by the second control unit based on the control command;
a04) after the step a03), checking the delete-able status of the deletion record file;
a05) switching the state of the delete-able status of the deletion record file by the second control unit based on the control command; and
a06) turning off the computer to power-off the hard disk drive.

16. The data deleting method for a computer storage device according to claim 15, wherein the central processing unit sends the control command via control software stored in the second working memory.

17. The data deleting method for a computer storage device according to claim 15, prior to the step a02), further including a step a021) of authenticating a key password.

18. The data deleting method for a computer storage device according to claim 10, wherein the deletion record file is a flag in the second working memory.
